(19) United States
(12) Patent Application Publication
(10) Pub. No.: US 2011/0257056 A1
(43) Pub. Date: Oct. 20, 2011

(54) SOLUTION FOR REMOVING TITANIUM-CONTAINING COATINGS AND REMOVING METHOD USING SAME

(75) Inventors: WEI HUANG, Shenzhen City (CN); HONG-LI GONG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/974,194

(22) Filed: Dec. 21, 2010

(30) Foreign Application Priority Data
Apr. 20, 2010 (CN) 201010151282.7

(51) Int. Cl. C11D 3/39

(52) U.S. Cl. 510/109

(57) ABSTRACT

A solution for removing titanium-containing coatings from substrates is provided. The solution includes hydrogen peroxide and fluoride. The hydrogen peroxide is in a concentration of about 100-800 ml/L. The fluoride is in a concentration of about 1-50 g/L. A method for removing titanium-containing coating from a substrate is also described there.

### CROSS-REFERENCE TO RELATED APPLICATIONS

This application is one of the five related co-pending U.S. patent applications listed below. All listed applications have the same assignee. The disclosure of each of the listed applications is incorporated by reference into all the other listed applications.

| Attorney | | |
|---|---|---|
| Docket No. | Title | Inventors |
| US 33408 | ELECTROLYTE FOR REMOVING | WEI HUANG |
| | TITANIUM-CONTAINING COATINGS | et al. |
| | AND REMOVING | |
| | METHOD USING SAME | |
| US 33410 | SOLUTION FOR REMOVING | WEI HUANG |
| | TITANIUM-CONTAINING COATINGS | et al. |
| | AND REMOVING | |
| | METHOD USING SAME | |
| US 33411 | SOLUTION FOR REMOVING | WEI HUANG |
| | TITANIUM-CONTAINING | et al. |
| | COATINGS AND | |
| | METHOD FOR SAME | |
| US 33412 | SOLUTION FOR ELECTROLYTICALLY | WEI HUANG |
| | REMOVING CHROMIUM CARBIDE | et al. |
| | COATING AND METHOD FOR | |
| | SAME | |
| US 33413 | SOLUTION SYSTEM | WEI HUANG |
| | FOR ELECTROLYTICALLY | et al. |
| | REMOVING TITANIUM | |
| | CARBIDE COATING AND | |
| | METHOD FOR SAME | |

### BACKGROUND

1. Technical Field

The present disclosure relates to a solution for removing titanium-containing coatings and a method for removing such coatings.

2. Description of Related Art

Hard titanium containing coatings, such as titanium nitride and titanium carbide, impart specific properties to workpieces such as machining tools, die core-pins, and high temperature devices. These hard coatings resist wear, abrasion, oxidation, and corrosion, and reduce susceptibility to chemical reactions on the workpieces to which they are applied. These coatings, however, can fail locally during manufacture or use.

When the coatings fail, the entire die or tool component is discarded even if the underlying substrate shows no damage, at considerable cost. For this reason, the ability to recycle the underlying substrate by removing a failed coating and replacing it with a new coating is economically preferable.

Therefore, there is room for improvement within the art.

### DETAILED DESCRIPTION

The present disclosure relates to a solution and a related method for removing titanium-containing coatings formed on the surfaces of substrates. The titanium-containing coatings may be titanium nitride coatings, titanium carbide coatings, titanium aluminum nitride coatings, or other titanium containing coatings formed by vacuum deposition. The substrate may be made of stainless steel, ferric-based alloy, or plastic.

The solution may be an aqueous solution containing hydrogen peroxide (H₂O₂) and fluoride.

The solution may have a concentration of about 100-800 ml/L of hydrogen peroxide, and in this exemplary embodiment the concentration is about 100-700 ml/L. The hydrogen peroxide is capable of oxidizing the titanium element contained in the coatings to Ti⁴⁺.

The fluoride may be one or more selected from a group consisting of ammonium hydrogen fluoride, sodium fluoride, potassium fluoride, sodium fluoroborate, and sodium fluorozirconate. Ammonium hydrogen fluoride is selected in this exemplary embodiment. The concentration of the fluoride may be about 1-50 g/L, and in this exemplary embodiment is about 1-25 g/L. The fluoride is capable of reacting with the Ti⁴⁺ and forming titanium tetrafluoride (TiF₄) to dissolve into the solution, as such the titanium-containing coatings are removed.

The solution may be prepared by dissolving the hydrogen peroxide and fluoride in water.

The method for removing the titanium-containing coating formed on the substrate may include steps of providing the solution, and contacting the substrate combined with the titanium-containing coating with the solution for about 2-30 minutes. The means of the contacting may be immersing the substrate in the solution or spraying the substrate by the solution. The solution may have a temperature of about 20-90° C. After contacting, the substrate may be rinsed with water and dried. The coating can be effectively removed from the substrate and the underlying substrate is free from damage by the present method.

### EXAMPLES

Experimental examples of the present disclosure follow:

### Example 1

1000 ml solution was provided. The solution consisted of hydrogen peroxide in a concentration of 100 ml/L, ammonium hydrogen fluoride in a concentration of 2.5 g/L, and deionized water. The solution was then heated to about 60° C.

Samples of stainless steel substrate coated with titanium aluminum nitride coatings were provided. The samples were completely immersed in the solution for about 10 minutes. During this process, the coatings were removed by the solution. Then, the samples were taken out of the solution and were dried after being rinsed with water.

### Example 2

1000 ml solution was provided. The solution consisted of hydrogen peroxide in a concentration of 200 ml/L, ammonium hydrogen fluoride in a concentration of 30 g/L, and deionized water. The solution was then heated to be about 50° C.

Samples of stainless steel substrate coated with titanium aluminum nitride coatings were provided. The samples were completely immersed in the solution for about 8 minutes. During this process, the coatings were removed by the solution. Then, the samples were taken out of the solution and were dried after being rinsed with water.

### Example 3

1000 ml solution was provided. The solution consisted of hydrogen peroxide in a concentration of 500 ml/L, ammonium hydrogen fluoride in a concentration of 2 g/L, and deionized water. The solution was then heated to be about 60° C.

Samples of stainless steel substrate coated with titanium aluminum nitride coatings were provided. The samples were completely immersed in the solution for about 6 minutes. During this process, the coatings were removed by the solution. Then, the samples were taken out of the solution and were dried after being rinsed with water.

### Example 4

1000 ml solution was provided. The solution consisted of hydrogen peroxide in a concentration of 800 ml/L, ammonium hydrogen fluoride in a concentration of 50 g/L, and deionized water. The solution was then heated to be about 70° C.

Samples of stainless steel substrate coated with titanium aluminum nitride coatings were provided. The samples were completely immersed in the solution for about 5 minutes. During this process, the coatings were removed by the solution. Then, the samples were taken out of the solution and were dried after being rinsed with water.

### Examples 5-8

In examples 5-8, the solutions were respectively made according to the examples 1-4. Unlike the examples 1-4, the sample substrates were made of ferric-based alloy. Except the above difference, the remaining experiment conditions of examples 5-8 were respectively the same as in examples 1-4.

### Examples 9-12

In examples 9-12, the solutions were respectively made according to the examples 1-4. Unlike the examples 1-4, the sample substrates were made of plastic. Except the above difference, the remaining experiment conditions of examples 9-12 were respectively the same as in examples 1-4.

### Examples 13-16

In examples 13-16, the solutions were respectively made according to the examples 1-4. Unlike the examples 1-4, the sample stainless steel substrates were coated with titanium carbide coatings, and the removing process in example was prolonged 5-6 minutes. Except the above difference, the remaining experiment conditions of examples 13-16 were respectively the same as in examples 1-4.

### Examples 17-20

In examples 17-20, the solutions were respectively made according to the examples 1-4. Unlike the examples 1-4, the sample stainless steel substrates were coated with titanium nitride coatings. Except the above difference, the remaining experiment conditions of examples 17-20 were respectively the same as in examples 1-4.

### Examples 21-40

In examples 21-40, the solutions were respectively made according to the examples 1-20. Unlike the examples 1-20, the samples were sprayed with the solution instead of being immersed in the solution. Except the above difference, the remaining experiment conditions of examples 21-40 were respectively the same as in examples 1-20.

### Results of the Examples 1-40

The samples processed in the examples 1-40 were inspected using X-ray diffraction (X-RD). No titanium and aluminum were detected on the samples. Accordingly, the coatings were effectively and completely removed from the underlying substrates. Furthermore, the processed samples were scanned using scanning electron microscopy. The scanning found no damage to the underlying substrates.

It is believed that the present embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A solution for removing titanium-containing coatings from a substrate, comprising:
hydrogen peroxide having a concentration of about 100-800 ml/L; and
fluoride having a concentration of about 1-50 g/L.

2. The solution as claimed in claim 1, wherein the hydrogen peroxide has a concentration of about 100-700 ml/L.

3. The solution as claimed in claim 1, wherein the fluoride is one or more selected from a group consisting of ammonium hydrogen fluoride, sodium fluoride, potassium fluoride, sodium fluoroborate, and sodium fluorozirconate.

4. The solution as claimed in claim 1, wherein the fluoride is ammonium hydrogen fluoride.

5. The solution as claimed in claim 1, wherein the fluoride has a concentration of about 1-25 g/L.

6. A method for removing a titanium-containing coating from a substrate, comprising:
providing an solution comprising hydrogen peroxide having a concentration of about 100-800 ml/L, and fluoride having a concentration of about 1-50 g/L; and
contacting the substrate having the titanium-containing coating with the solution.

7. The method as claimed in claim 6, wherein the hydrogen peroxide has a concentration of about 100-700 ml/L.

8. The method as claimed in claim 6, wherein the fluoride is one or more selected from a group consisting of ammonium hydrogen fluoride, sodium fluoride, potassium fluoride, sodium fluoroborate, and sodium fluorozirconate.

9. The method as claimed in claim 6, wherein the fluoride is ammonium hydrogen fluoride.

10. The method as claimed in claim 6, wherein the fluoride has a concentration of about 1-25 g/L.

11. The method as claimed in claim 6, wherein the contacting includes the means of immersing the substrate in the solution or spraying the substrate by the solution.

12. The method as claimed in claim 11, wherein the contacting lasts for about 2-30 minutes.

13. The method as claimed in claim 6, wherein the solution has a temperature of about 20-90° C.

14. The method as claimed in claim 6, wherein the substrate is made of stainless steel, ferric-based alloy, or plastic.

15. The method as claimed in claim 6, wherein the titanium-containing coating is titanium aluminum nitride coating, titanium carbide coating, titanium nitride, or other titanium containing coating.
